(19) United States
(12) Patent Application Publication
(10) Pub. No.: US 2022/0091905 A1
(43) Pub. Date: Mar. 24, 2022

(54) METHOD AND DEVICE FOR PROVIDING APPLICATION LIST BY ELECTRONIC DEVICE

(71) Applicant: Samsung Electronics Co., Ltd., Gyeonggi-do (KR)

(72) Inventors: Wonjun LEE, Gyeonggi-do (KR); Dasom KIM, Gyeonggi-do (KR); Jieun YANG, Gyeonggi-do (KR); Sangeun LEE, Gyeonggi-do (KR); Kyungwha HONG, Gyeonggi-do (KR)

(21) Appl. No.: 17/424,978

(22) PCT Filed: Jan. 22, 2020
(86) PCT No.: PCT/KR2020/001094

§ 371 Date: Jul. 22, 2021

(30) Foreign Application Priority Data
Jan. 22, 2019 (KR) 10-2019-0007977

(51) Int. Cl. G06F 9/50

(52) U.S. Cl. CPC G06F 9/5088

(57) ABSTRACT

Various embodiments of the present disclosure provide a method and a device for providing an application list by an electronic device. According to various embodiments, the electronic device may comprise a display, and at least one processor operatively connected to the display, wherein the processor: displays a first user interface through the display; receives a user input related to task switching; configures, before the task switching according to the user input, a second user interface including a recent list related to a recently used application and a recommendation list related to a recommendation task; and switches the first user interface to the second user interface and displays the second user interface. Various embodiments are possible.

### TECHNICAL FIELD

The disclosure relates to a method and apparatus for providing an application list by an electronic device.

### BACKGROUND ART

As digital technologies have been developed, various types of electronic devices have come to be popular, such as a mobile communication terminal, a smart phone, a tablet personal computer (PC), a notebook, a wearable device, a digital camera, a personal computer, or the like.

An electronic device may install various applications that a user wants to use. The electronic device may produce icons corresponding to the installed applications and may dispose the icons in the application list of the electronic device, so as to provide the same to the user. Recently, to enable a user to easily search for an application, the electronic device provides a recent application list related to applications that the user recently uses. For example, the electronic device may configure a recent application list based on the screenshots (or shortcuts or thumbnails) of applications that the user recently uses, and may display the recent application list on a display based on a user input.

However, the application list provides only a list related to applications that the user uses, irrespective of the situation that the user is in. Accordingly, the application list provides only a list related to applications that the user desires to use subsequently, or a list related to applications that are irrelevant to the situation that the user is in. For example, the application list shows a list related to usage history of recently used applications, and enables the user to easily search the applications that the user has recently used. However, the application list related to recently used applications does not provide (e.g., recommend) an application that is appropriate for the situation of the user or an application that the user desires to use subsequently, and thus, user needs for those services may arise.

### DISCLOSURE OF INVENTION

### Technical Problem

Various embodiments disclose a method and apparatus for providing an application list including applications recently used in an electronic device and recommended applications having a high probability of being used by a user.

Various embodiments disclose a method and apparatus for providing an application list in an electronic device by displaying a recent application list and a recommended task list together and distinctively in the application list.

Various embodiments disclose a method and apparatus for predicting, based on the context related to a user, a task (e.g., an application, a function, contents, and/or a link) that a user is to use (or perform) subsequently in an electronic device, and providing a task object (or task information) related to the corresponding task via a user interface related to an application list.

Various embodiments disclose a method and apparatus for increasing accuracy of recommendation in association with user's favorite task, and configuring improved. task information by providing a recommend list based on an exception task among recommendable tasks when providing an application list.

### Solution to Problem

In accordance with an aspect of the disclosure, an electronic device includes a display and at least one processor operatively connected to the display, wherein the processor is configured to display a first user interface via the display; receive a user input related to task switching; configure a second user interface including a recent list related to a recently used application and a recommend list related to a recommended task; and switch the first user interface to the second user interface and display the second user interface.

In accordance with an aspect of the disclosure, an operation method of an electronic device may include: displaying a first user interface on a display; receiving a user input related to task switching; configuring a second user interface including a recent list related to a recently used application and a recommend list related to a recommended task; and switching the first user interface to the second user interface and displaying the second user interface.

To solve the above-described problems, various embodiments of the disclosure may include a computer-readable recording medium that stores a program for implementing the method in a processor.

### Advantageous Effects of the Invention

According to an electronic device and an operation method thereof according to various embodiments, a user can easily perform task switching in the electronic device 101. According to various embodiments, an application list can be provided, including a recent list related to a recently used application and a recommend list related to a recommended task expected to have a high probability of being used by a user at the present. According to various embodiments, an application list provides a recent application list and a recommended task list together, and at the same time, distinctively. According to various embodiments, based on context related to a user, a task (e.g., an application, a function, contents, and/or a link) that a user is to use (or perform) subsequently in an electronic device can be predicted, and a task object (or task information) related to the corresponding task can be provided via a user interface related to an application list.

According to various embodiments, accuracy of recommendation in association with a favorite task of a user can be increased by providing a recommend list based on an exception task among recommendable tasks when providing an application list, and improved task information can be configured. According to various embodiments, accuracy of a recommended task can be improved by adjusting a weight applied to, or excluding, an application that a user passes through in a path for accessing a recent screen for an application list or a task (e.g., an application) related to a predetermined component e.g., (UI component) from a recommended task, when providing a recommend list.

### BRIEF DESCRIPTION OF DRAWINGS

FIG. 1 illustrates an electronic device in a network environment according to an embodiment;

FIG. 2 is a diagram illustrating an example of a function processing module in an electronic device according to various embodiments;

FIG. 3 is a flowchart illustrating an operation method of an electronic device according to various embodiments;

FIG. 4 is a diagram illustrating an example of a user interface provided in an electronic device according to various embodiments;

FIG. 5 is a flowchart illustrating an operation method of an electronic device according to various embodiments;

FIG. 6 is a flowchart illustrating an operation method of an electronic device according to various embodiments;

FIG. 7 is a flowchart illustrating an operation method of an electronic device according to various embodiments;

FIG. 8 is a flowchart illustrating an operation method of an electronic device according to various embodiments;

FIG. 9 is a diagram illustrating an example of providing a user interface according to various embodiments;

FIG. 10 is a diagram illustrating an example of providing a user interface according to various embodiments;

FIG. 11 is a flowchart illustrating an operation method of the electronic device 101 according to various embodiments;

FIG. 12 is a diagram illustrating an example of providing a user interface according to various embodiments;

FIG. 13 is a diagram illustrating an example of providing a user interface according to various embodiments;

FIG. 14 is a flowchart illustrating an operation method of the electronic device 101 according to various embodiments;

FIG. 15 is a diagram illustrating an example of providing a user interface according to various embodiments;

FIG. 16 is a diagram illustrating an example of providing a user interface according to various embodiments;

FIG. 17 is a diagram illustrating an example of providing a user interface according to various embodiments; and

FIGS. 18 and 19 are diagrams illustrating examples of interaction with a user based on a user interface according to various embodiments.

### MODE FOR THE INVENTION

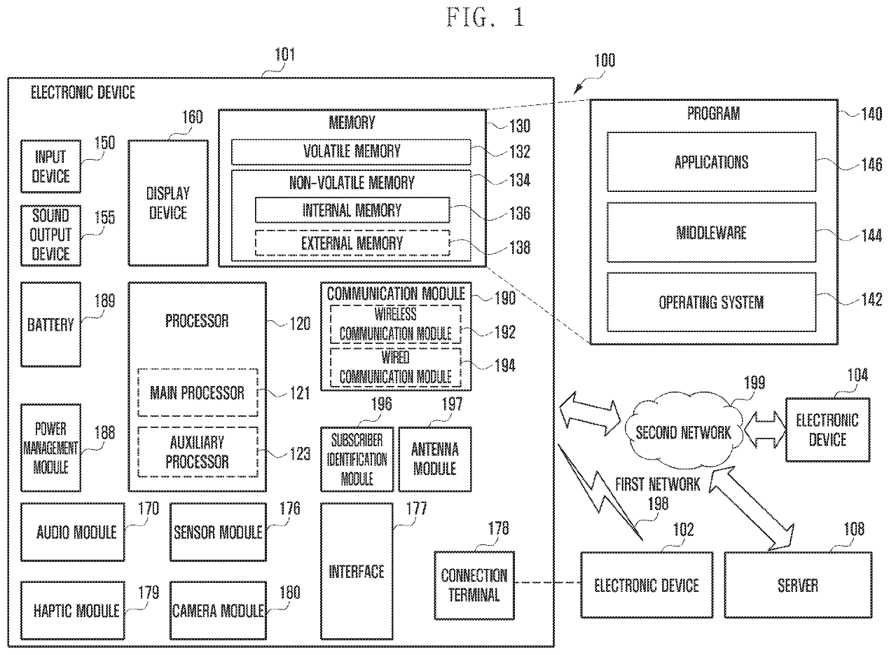

FIG. 1 illustrates an electronic device 101 in a network environment 100 according to an embodiment.

Referring to FIG. 1, the electronic device 101 in the network environment 100 may communicate with an electronic device 102 via a first network 198 (e.g., a short-range wireless communication network), with an electronic device 104 or a server 108 via a second network 199 (e.g., a long-range wireless communication network), or with the electronic device 104 via the server 108, and may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) card 196, and an antenna module 197. At least one (e.g., the display device 160 or the camera module 180) of the components may be omitted from the electronic device 101, or one or more other components may be added in the electronic device 101. Some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. The processor 120 may load a command or data received from another component (e.g., the sensor module 176 or the communication module 190) in the volatile memory 132, process the command or the data stored in the volatile memory 132, and store resulting data in non-volatile memory 134. The processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). The auxiliary processor 123 (e.g., an image signal processor or a communication processor) may be implemented as part of another component (e.g., the camera module ISO or the communication module 190) functionally related to the auxiliary processor 123.

The memory 130 may store various data used by at least one component (e.g., the processor 120 or the sensor module 176) of the electronic device 101 and may include software (e.g., the program 140) and input data or output data for a command related thereto. The memory 130 may include the volatile memory 132 or the non-volatile memory 134.

The program 140 may be stored in the memory 130 as software, and may include an operating system (OS) 142, middleware 144, or an application 146.

The input device 150 may receive a command or data to be used by another component (e.g., the processor 120) of the electronic device 101, from the outside (e.g., a user) of the electronic device 101, and may include a microphone, a mouse, a keyboard, or a digital pen (e.g., a stylus pen).

The sound output device 155 may output sound signals to the outside of the electronic device 101 and may include a speaker or a receiver. The speaker may be used for general purposes, such as playing multimedia or playing record, and the receiver may be used for incoming calls and may be implemented as separate from, or as part of the speaker.

The display device 160 may visually provide information to the outside (e.g., a user) of the electronic device 101 and may include a display, a hologram device, or a projector and control circuitry to control a corresponding one of the display, hologram device, and projector. The display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa, and may obtain the sound via the input device 150, or output the sound via the sound output device 155 or a headphone of an external electronic device (e.g., an electronic device 102) directly (e.g., over wires) or wirelessly coupled with the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state, and may include a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., over wires) or wirelessly, and may include a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102), and may include a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation, and may include a motor, a piezoelectric element, or an electric stimulator.

The camera module 180 may capture a still image or moving images and may include one or more lenses, image sensors, image signal processors, or flashes.

The power management module 188 may manage power supplied to the electronic device 101, and may be implemented as at least part of a power management integrated circuit (PMIC).

The battery 189 may supply power to at least one component of the electronic device 101, and may include a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., a LAN or a wide area network (WAN)). These various types of communication modules may be implemented as a single component (e.g., a single chip), or may be implemented as multi components (e.g., multi chips) separate from each other.

The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101 and may include an antenna including a radiating element composed of a conductive material or a conductive pattern formed in or on a substrate (e.g., a PCB). The antenna module 197 may include a plurality of antennas. In such a case, at least one antenna appropriate for a communication scheme used in the communication network, such as the first network 198 or the second network 199, may be selected by the communication module 190 (e.g., the wireless communication module 192) from the plurality of antennas. The signal or the power may then be transmitted or received between the communication module 190 and the external electronic device via the selected at least one antenna. Another component (e.g., an RFIC) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or received between the electronic device 101 and the external electronic device 104 via the server 108 coupled with the second network 199. Each of the electronic devices 102 and 104 may be a device of a same type as, or a different type, from the electronic device 101.

All or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing, as at least part of a reply to the request. To that end, a cloud, distributed, or client-server computing technology may be used, for example.

The electronic device 101 according to embodiments may be one of various types of electronic devices, such as a portable communication device (e.g., a smartphone), a computer device, a portable multimedia device, a portable medical device, a camera, a wearable device, or a home appliance. However, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B. or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., over wires), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The math ne-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

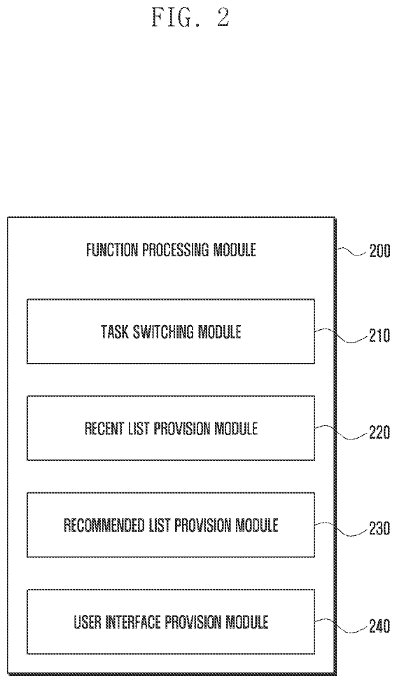

FIG. 2 is a diagram illustrating an example of a function processing module 200 in an electronic device, according to an embodiment.

Referring to FIG. 2, an example of the function processing module 200 that performs a function related to providing a user interface including a recent list related to a recently used application and a recommend list related to a recommended task according to various embodiments. For example, FIG. 2 illustrates an example of the function processing module 200 which relates to improving accuracy related to a recommended task by performing exception handling on at least some tasks when providing a recommend list via a user interface as task switching is performed. According to various embodiments, the functional module 200 may be included as a hardware module or a software module in at least one processor (e.g., the processor 120 of FIG. 1) including a processing circuit (processing circuitry).

Referring to FIG. 2, the function processing module 200 includes a task switching module 210, a recent list provision module 220, a recommend list provision module 230, and a user interface provision module 240.

According to an embodiment, the task switching module 210 may detect a user input related to task switching. According to an embodiment, the task switching module 210 may detect a user input for switching a task in the state in which a user interface related to a predetermined application (e.g., an application execution screen or a home screen) is displayed. According to an embodiment, a user input related to task switching may include, for example, a user input via a designated button (e.g., a soft button (or a soft key) or a physical button (or a physical key)) for displaying an application list (or a user interface including an application list) in the electronic device 101. According to an embodiment, a user input related to task switching may include, for example, a designated voice input (or a voice command) for displaying an application list. According to an embodiment, the task switching module 210 may receive a designated user input related to task switching, and may trigger task switching based on the reception of the user input.

According to an embodiment, the recent list provision module 220 may identify an application related to a recent list when task switching is performed. According to an embodiment, the recent list may include, for example, a recent application list related to at least one recent application which is used by a user in the electronic device 101. According to an embodiment, the recent list may be configured based on an application object (e.g., an icon or a screenshot (or a shortcut, or a thumbnail)) related to an application.

According to an embodiment, the recommend list provision module 230 may identify a task related to a recommend list (suggestion list) when task switching is performed. According to an embodiment, the recommend list may include, for example, a recommended task list related to at least one task (e.g., an application, a function, contents, and/or a link) associated with a user (or the context of a user) at the present. According to an embodiment, the recommend list may be configured based on a task object (e.g., an icon, text (e.g., link information), an image, a video, a thumbnail, and/or a widget icon) related to a task. According to an embodiment, a task associated with a user may be, for example, a task predicted to be executed subsequently by the user based on the context of the user. For example, the task associated with the user (or the predicted task) may be a task having a high probability of being used (or executed) by the user via task switching, and may be predicted based on various tasks such as applications, functions, contents, and/or links. According to an embodiment, the recommend list provision module 230 may exclude a designated task (e.g., an exception task) (e.g., a task or a routine that complies with exceptions) among predicted tasks, or may apply (or set) a weight (e.g., minus weight) related to the designated task. According to various embodiments, the recommend list provision module 230 may perform exception handling on a task that is highly accessible by a user, so as to except the task from a recommended task, in order to increase accuracy of task recommendation.

According to an embodiment, the recommend list provision module 230 may perform exception handling on (or exclude or apply a minus weight to) a task (e.g., an application or a function) that a user is capable of easily searching for and executing via the electronic device 101, so as to except the task from a recommended task. According to an embodiment, a task or routine on which exception handling is to be performed may be included in previously defined exceptions, and may be managed. According to an embodiment, the exceptions may include a task that is easily accessible by a user or was used immediately before, such as a flow (e.g., a user interface flow) (e.g., a task (e.g., an application) fixedly provided in a home screen (or a page) if task switching is performed via the home screen) performed to access a user interface (e.g., a recent screen) including an application list (e.g., a recent list and a recommend list) when the user performs task switching, a task (e.g., an edge, a floating button, a lock screen, and/or a widget) associated with a predetermined component (e.g., a shortcut user interface component), a task in which a user stayed (or used) before performing task switching, and/or an application (e.g., an application corresponding to a screenshot or icon in a recent list) included in the recent list, and may perform exception handling on (e.g., exclude or apply a minus weight to) a task that complies with exceptions, so as to except the task from. a recommended task. According to various embodiments, the process of performing exception handling on a task will be described with reference to drawings described below.

According to an embodiment, the user interface provision module 240 may provide a user interface related to an application list including a recent list related to a recently used application and a recommend list related to a recommended task, when task switching is performed. According to an embodiment, the user interface provision module 240 may display a user interface (e.g., an application list) including a recent list and a recommend list on a display (e.g., the display device 160 of FIG. 1). According to an embodiment, the user interface provision module 240 may display a recent list related to a recently used application and a recommend list related to a recommended task together in an application list (or a user interface), and at the same time, may display the recent list and recommend list distinctively.

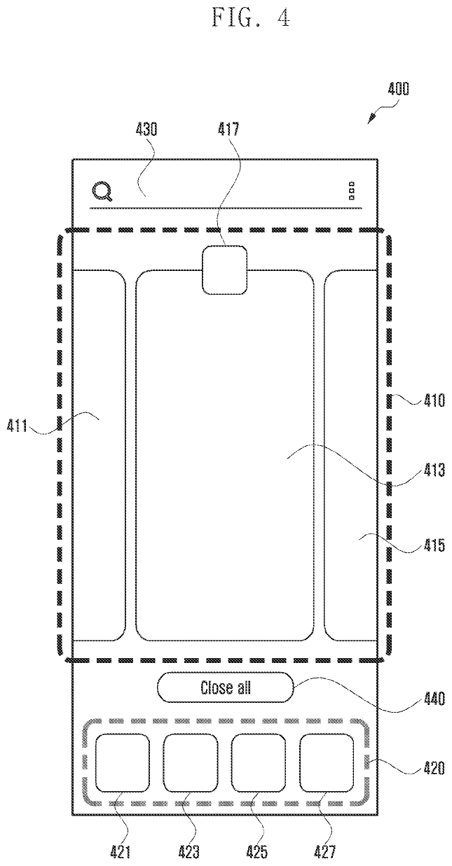

An electronic device 101 according to various embodiments may include a display (e.g., the display device 160 of FIG. 1) and at least one processor (e.g., the processor 120 of FIG. 1) operatively connected to the display, and the processor 120 may display a first user interface via the display, may receive a user input related to task switching, may configure a second user interface (e.g., the user interface 400 of FIG. 4) including a recent list related to a recently used application and a recommend list related to a recommended task, and may switch the first user interface to the second user interface and display the second user interface.

According to various embodiments, the processor 120 may predict a recommended task related to at least one task associated with user context, and may configure the recommend list based on a task object related to the recommended task.

According to various embodiments, the recommended task is a task having a high probability of being used by a user via task switching, and may include at least one of an application, a function, contents, or a link.

According to various embodiments, the processor 120 may perform exception handling on a task that is highly accessible by a user so as to except the task from the recommended task.

According to various embodiments, the processor 120 may predict the recommended task, and may exclude a designated task among predicted tasks or may apply a weight related to the designated task.

According to various embodiments, the task on which exception handling is performed may include a flow performed up to access to the second user interface, a task associated with a predetermined component, a task in which a user stayed before task switching is performed, or at least one application included in the recent list.

According to various embodiments, the processor 120 may predict the recommended task, may configure a candidate task list based on a result of the prediction, may identify a designated exception task, may perform exception handing on the exception task in the candidate task list, and may provide the recommend list based on the exception handing performed on the exception task in the candidate task list.

According to various embodiments, the user input related to task switching may include a user input by a designated button for displaying the second user interface or a designated voice input.

According to various embodiments, the processor 120 may dispose the recent list in a first area of the second user interface and may dispose the recommend list in a second area of the second user interface, so as to display the recent list and the recommend list together, and, at the same time, to display the recent list and the recommend list distinctively.

According to various embodiments, the processor 120 may predict a task which is expected to be executed by a user, using a learning model learned via an artificial intelligence algorithm.

According to various embodiments, the processor 120 may predict a task expected to be executed by a user using a learning model learned based on at least one of machine learning, neural network, genetic, deep learning, or classification algorithm as the artificial intelligence algorithm.

According to various embodiments, operations performed in the electronic device 101 may be executed by at least one processor of the electronic device 101 (e.g., at least one processor including a processing circuit, for example, the processor 120 of FIG. 1 (hereinafter, referred to as the processor 120). According to an embodiment, the operations performed by the electronic device 101 may be stored in a memory (e.g., the memory 130 of FIG. 1) (hereinafter, referred to as the memory 130), and may be executed according to instructions configured to enable the processor 120 to perform operation when the instructions are executed.

According to various embodiments, the electronic device 101 may include a display (e.g., the display device 160 of FIG. 1), the at least one processor 120 operatively connected to the display, and the memory 130 operatively connected to the processor 120. According to an embodiment, the memory 130 may be configured to store related data for a recent list and related data for a recommend list.

According to various embodiments, the processor 120 may perform an operation related to predicting (or calculating) a task which is expected to be executed by a user, using a learning model learned via an artificial intelligence (AI) algorithm. According to an embodiment, the processor 120 may perform an operation related to predicting (or calculating) a task expected to be executed by a user using, for example, at least one of machine learning, neural network, genetic, deep learning, or classification algorithm as the artificial intelligence algorithm.

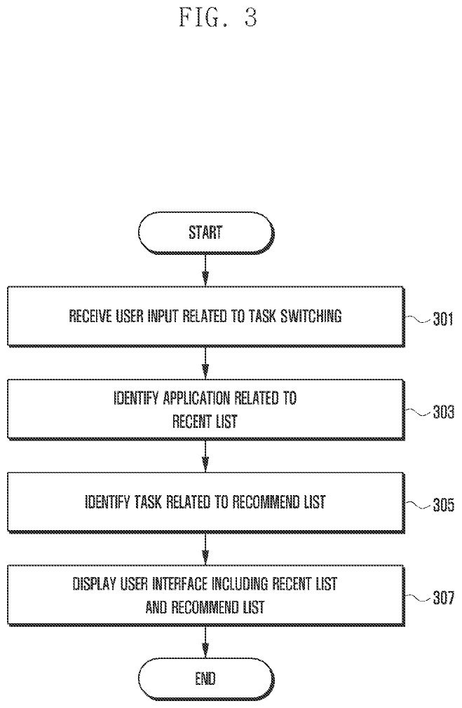

FIG. 3 is a flowchart illustrating an operation method of the electronic device 101 according to various embodiments.

According to an embodiment, FIG. 3 illustrates an example of providing a user interface including a first list related to an application and a second list related to a task when the electronic device 101 performs task switching.

Referring to FIG. 3, in operation 301, the processor 120 of the electronic device 101 may receive a user input relate to task switching. According to an embodiment, the processor 120 may receive a user input for switching a task in the state in which a user interface related to a predetermined application (e.g., an application execution screen or a home screen) is displayed. According to an embodiment, a user input related to task switching may include, for example, a user input via a designated button (e.g., a soft button (or a soft key) or a physical button (or a physical key)) for displaying an application list (or a user interface including an application list) in the electronic device 101. According to an embodiment, a user input related to task switching may include, for example, a designated voice input (or voice command) for displaying an application list.

In operation 303, the processor 120 may identify an application related to a recent list. According to an embodiment, the recent list may include, for example, a recent application list related to at least one recent application used by a user in the electronic device 101. According to an embodiment, the recent list may be configured based on an application object (e.g., an icon, a screenshot, a shortcut, or a thumbnail) related to an application.

In operation 305, the processor 120 may identify a task related to a recommend list (or a suggestion list). According to an embodiment, the recommend list may include, for example, a recommended task list related to at least one task (e.g., an application, a function, contents, and/or a link) associated with a user (or the context of a user) at the present. According to an embodiment, the recommend list may be configured based on a task object (e.g., an icon, text (e.g., link information), an image, a video, a thumbnail, and/or a widget icon) related to a task. According to an embodiment, a task associated with a user may be, for example, a task predicted to be executed subsequently by the user based on the context of the user. For example, the task associated with the user may be a task having a high probability of being used (or executed) by the user via task switching, and may be predicted based on various tasks such as an application, a function, a content, and/or a link. According to various embodiments, the process of predicting the task associated with the user will be described with reference to drawings described below. According to an embodiment, operations 303 and 305 may be performed in sequence, in parallel, or in reverse order.

In operation 307, the processor 120 may display a user interface (e.g., an application list) including the recent list and the recommend list on a display (e.g., the display device 160 of FIG. 1). According to an embodiment, the processor 120 may display the recent list related to a recently used application and the recommend list related to a recommended task together in the application list (or the user interface), and at the same time, may display the recent list and recommend list distinctively. According to various embodiments, a user interface related to an application list will be described with reference to drawings described below.

FIG. 4 is a diagram illustrating an example of a user interface 400 provided in the electronic device 101 according to various embodiments.

According to an embodiment, FIG-. 4 illustrates an example of the user interface 400 related to an application list which is divided into a recent list and a recommend list according to various embodiments.

Referring to FIG. 4, the user interface 400 may include a first area 410 for a recent list related to an application and a second area 420 for a recommend list related to a task. According to various embodiments, the recent list based on the first area 410 and the recommend list based on the second area 420 are provided together, and at the same time, the recent list and the recommend list may be provided distinctively and independently.

According to an embodiment, the first area 410 may be, for example, a recent area that provides information related to a recently used application. According to an embodiment, the first area 410 may provide the recent list based on the screenshot (or the shortcut or the thumbnail) 411, 413, and 415 related to at least one application (e.g., application A, application B, and application C) recently used by a user.

According to an embodiment, the electronic device 101 may provide interaction with the user based on the first area 410. For example, the electronic device 101 may receive a user input (e.g., a first user input) via the first area 410, may execute an application (e.g., application A, application B, or application C) related to a screenshot 411, 413, or 415 designated (or selected) by the user input, and may display a user interface (e.g., an application execution screen) related to the executed application. As another example, the electronic device 101 may receive a user input (e.g., a second user input) via the first area 410, and may perform navigation among applications (or the screenshots 411, 413, and 415) according to the user input so as to enable a screenshot (e.g., the screenshot 413) displayed in the center of the first area 410 to be located and displayed in an adjacent screenshot (the screenshot 411 or the screenshot 415) corresponding to a movement direction of the user input (e.g., to the left (e.g., swipe left) or to the right (e.g., swipe light)). According to an embodiment, the first user input and the second user input may be different types of user inputs. For example, if the first user input is a touch input, the second user input may be a swipe gesture (e.g., swipe down/up/left/right).

According to an embodiment, the second area 420 may be, for example, a recommendation area that provides information related to a recommended task. According to an embodiment, the second area 420 may recommend a task (e.g., predict a task) which is expected to have a high probability of being used (or executed) (hereinafter, referred to as a probability of use) by the user subsequently (or currently) based on context related to the user (e.g., a usage pattern, time, place, and/or situation), and may provide a recommend list based on a task object 421, 423, 425, and 427 related to the predicted task (e.g., an icon, text (e.g., link information), an image, a video, a thumbnail, and/or a widget icon). According to an embodiment, a task. may include at least one element that the user is capable of using in the electronic device 101, such as an application, a function, a content, and/or a link which is expected to be used (or executed) subsequently by the user.

According to an embodiment, the electronic device 101 may provide interaction with the user based on the second area 420. For example, the electronic device 101 may receive a user input (e.g., a first user input) via the second area 420, may execute a task (e.g., an application, a function, a content, and/or a link) related to an object 421, 423, 425, or 427 designated (or selected) by the user input, and may display a user interface (e.g., an application execution screen, a function execution screen, a content execution screen, and/or a link execution screen) related to the executed task. As another example, the electronic device 101 may receive a user input (e.g., the second user input) via the second area 420, and may switch over to a task object (e.g., a second recommended group) other than a displayed task object 421, 423, 425, and 427 (e.g., a first recommended group), based on the user input, and may display the same. For example, the electronic device 101 may switch over to a task object (e.g., the second recommended group) related to a recommended task having a lower priority than that of the first recommended group. As another example, the electronic device 101 may receive a user input (e.g., a third user input) via the second area 420, may call (or execute) a function designated according to the user input (e.g., all applications or all recommended tasks), and may display a user interface related to the called designated function.

According to an embodiment, when providing a recommend list related to a task in the second area 420, the electronic device 101 may identify an exception task (e.g., an exception application) irrespective of the priority order of tasks determined based on probabilities of use, and may exclude the exception task from the recommend list. According to an embodiment, the process of configuring a recommend list based on an execution task will be described with reference to drawings described below. 1981 According to an embodiment, a predetermined (or a previously set) number (e.g., N) of task objects 421, 423, 425, and 427 may be included in the second area 420. For example, if the predetermined number is “4”, at least four task objects may be provided. If the predetermined number is “3”, at least three task objects may be provided. According to an embodiment, a recommended task for a recommend list may be recommended, for example, based on a predetermined number in association with task objects for the second area 420, based on a predetermined number (e.g., M) or based on the number of recommendable tasks without limitation of a number. According to an embodiment, if the number of recommended tasks for the recommend list is greater than a predetermined number (e.g., N) in association with task objects for the second area 420, task objects 421, 423, 425, and 427 of tasks, the number of which corresponds to the predetermined number, may be provided according to priority in the second area 420, and a task object of a task having a subsequent priority may be provided in the second area 420 via switching according to a user input.

According to an embodiment, based on a prediction result, if a recommended task related to the current context of the user is not present, a predetermined cue object (not illustrated) may be provided. According to an embodiment, provision of a cue object in the second area 420 will be described with reference to the drawings.

According to an embodiment, the user interface 400 may include a third area 430 and a fourth area 440, as illustrated in FIG. 4.

According to an embodiment, the third area 430 may be a search area (e.g., a search window) for searching for, for example, information (e.g., an application or a task) related to the recent list of the first area 410 and/or the recommend list of the second area 420. According to an embodiment, the fourth area 440 may be an object (e.g., a soft button) that closes all, for example, the items of the recent list of the first area 410 (e.g., the screenshots 411, 413, and 415 related to applications).

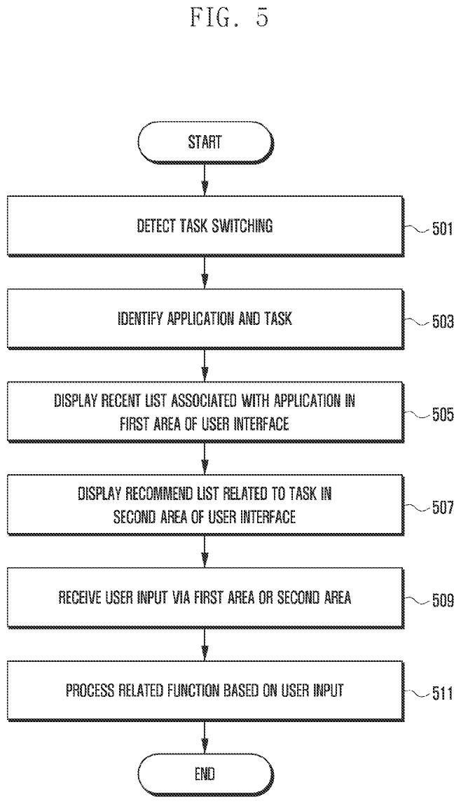

FIG. 5 is a flowchart illustrating an operation method of the electronic device 101 according to various embodiments.

According to an embodiment, FIG. 5 illustrates an example in which the electronic device 101 provides a recent list and a recommend list together, receives a user input via a first area (e.g., the first area. 410 of FIG. 4) for the recent list or a second area (e.g., the second area 420 of FIG. 4) for the recommend list, and performs an operation corresponding to the corresponding area based on the user input.

Referring to FIG. 5, in operation 501, the processor 120 of the electronic device 101 may detect task switching. According to an embodiment, the processor 120 may receive a user input for switching a task in the state in which a user interface (e.g., an application execution screen or a home screen) related to a predetermined task (e.g., an application) is displayed. According to an embodiment, task switching may be performed based on, for example, a user input via a predetermined button for displaying a user interface including the recent list related to a recently used application and the recommend list related to a recommended task in the electronic device 101. According to an embodiment, task switching may be performed based on, for example, a predetermined voice input.

In operation 503, the processor 120 may identify an application and a task. According to an embodiment, the processor 120 may identify an application related to the recent list and a task related to the recommend list. For example, the processor 120 may identify a recently used application for the recent list based on an application usage history of a user, and may predict a task expected to be used by the user based on the context of the user, and may identify a task for the recommend list based on the predicted task.

In operation 505, the processor 120 may display the recent list related to an application via a first area (e.g., the first area 410 of FIG. 4) of the user interface. According to an embodiment, the processor 120 may configure the recent list based on a screenshot related to the identified application, and may allocate (or dispose) the recent list in the first area of the user interface.

In operation 507, the processor 120 may display the recommend list related to a task via a second area (e.g., the second area 420 of FIG. 4) of the user interface. According to an embodiment, the processor 120 may configure the recommend list based on a task object related to the identified task, and may allocate (or dispose) the recommend list in the second area of the user interface.

According to an embodiment, operations 505 and 507 may be performed in sequence, in parallel, or in reverse order.

In operation 509, the processor 120 may receive a user input via the first area or the second area. According to an embodiment, the processor 120 receives, via the first area 410, a user input related to execution of an application or a user input related to navigation among the screenshots of applications. According to an embodiment, the processor 120 may receive, via the second area 420, a user input related to execution of a task or a user input related to navigation among task. objects of a task.

In operation 511, the processor 120 may process a related function based on the user input. According to an embodiment, based on the user input, the processor 120 may process a function corresponding to the user input, such as execution of an application selected in the first area, control of navigation among the screenshots of applications in the first area, execution of a task selected in the second area, or control of navigation among task objects in the second area. According to an embodiment, an operation of processing a related function based on a user input will be described with reference to the drawings.

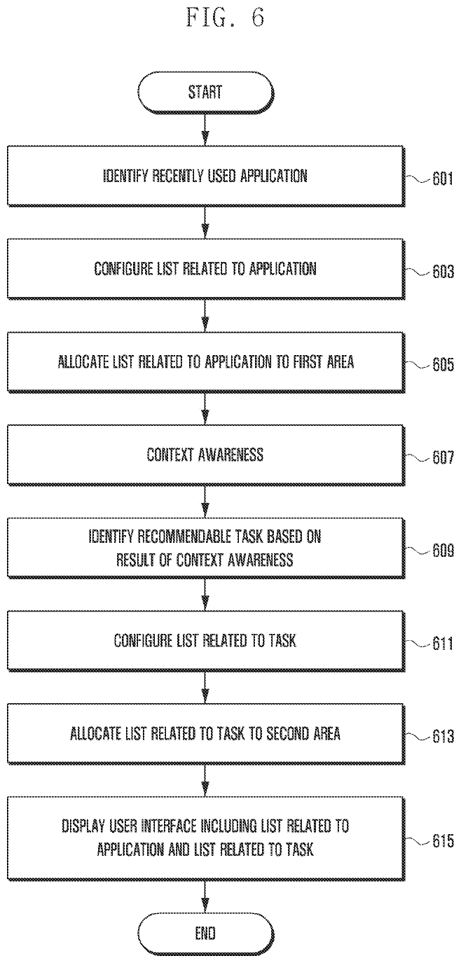

FIG. 6 is a flowchart illustrating an operation method of the electronic device 101 according to various embodiments.

According to an embodiment, FIG. 6 illustrates an example in which the electronic device 101 configures a list related to an application for a first area (e.g., the first area 410 of FIG. 4) of a user interface and a list related to a recommended task for a second area (e.g., the second area 420 of FIG. 4), may display the list related to an application and the list related to a recommended task in designated areas, respectively, and may provide the user interface.

Referring to FIG. 6, in operation 601, the processor 120 of the electronic device 101 may identify a recently used application. According to an embodiment, the processor 120 may identify a recently used application for a recent list based on an application usage history of a user.

In operation 603, the processor 120 may configure a list related to an application (e.g., a recent list). According to an embodiment, the processor 120 may configure the list related to an application based on a screenshot (or a shortcut or a thumbnail) corresponding to the identified application.

In operation 605, the processor 120 may allocate (or set) the list related to an application in a designated area (e.g., the first area 410) of the user interface.

In operation 607, the processor 120 may perform context awareness for a recommended task. According to an embodiment, the processor 120 may predict a task which is expected to be executed by the user at the present, based on context related to the usage of the electronic device 101 by the user (e.g., a usage pattern, time, place, and/or situation). According to an embodiment, operation 607 may be performed in parallel at the point in time of operation 607. According to an embodiment, predicting a recommended task based on context awareness will be described with reference to the drawings.

In operation 609, the processor 120 may identify a recommendable task based on a result of context awareness. According to an embodiment, the processor 120 may determine at least one task recommendable to the user is present based at least on the result of context awareness (e.g., a prediction result).

In operation 611, the processor 120 may configure a list related to a task (e.g., a recommend list). According to an embodiment, the processor 120 may configure a list related to a recommendable task based on a task object (e.g., an icon, text (e.g., link information), an image, a video, a thumbnail, and/or a widget icon) corresponding to the identified task.

In operation 613, the processor 120 may allocate (or set) the list related to a task in a designated area (e.g., the second area 420) of the user interface.

In operation 615, the processor 120 may display the user interface including the list related to an application and the list related to a task. According to an embodiment, the processor 120 may dispose the list related to an application, allocated to the first area, in the first area and dispose the list related to a task, allocated to the second area, in the second area, and may display, on a display (e.g., the display device 160 of FIG. 1), the user interface including the list related to an application and the list related to a task.

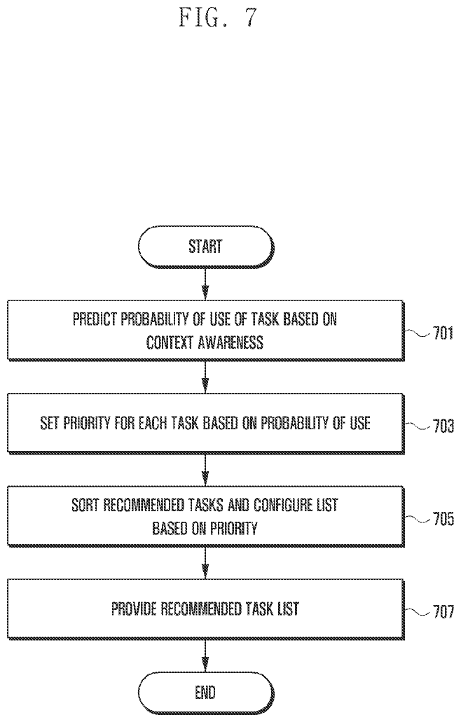

FIG. 7 is a flowchart illustrating an operation method of the electronic device 101 according to various embodiments.

According to an embodiment, FIG. 7 illustrates an example in which the electronic device 101 predicts a recommendable task based on context awareness, and provides a list related to a recommendable task based on a result of prediction.

Referring to FIG. 7, in operation 701, the processor 120 of the electronic device 101 may predict the probability of use of a task based on the context awareness for a recommended task. According to an embodiment, the processor 120 may perform context awareness for a recommendable task. According to an embodiment, the processor 120 may use a sensor, communication, and/or computing capability in order to recognize and determine various contexts related to use of the electronic device 101 by a user, and may predict a task executable by the user at the present point. For example, the executable task may be any task which can be used by the user at the present, and may include an application, a function, a content, and/or a link which is usable by the user.

According to an embodiment, the processor 120 may be aware of context information via collecting and exchanging context information related to a task, and may provide a task appropriate for the context of the user via a process such as interpretation and inference. According to an embodiment, the processor 120 may be aware of context information of the user, such as a task usage pattern, a usage situation (e.g., a time, a place, a predetermined situation), and/or the frequency of use for each usage situation, and may infer (or predict) one or more tasks expected to be executed (or expected to have a high probability of being used) by the user at the present point based on the context information. According to an embodiment, the processor 120 may use a learning module learned using an artificial intelligence algorithm, and may predict (or calculate) a task which is expected to be executed by the user.

In operation 703, the processor 120 may set a priority order of tasks based on the probabilities of use of tasks predicted. According to an embodiment, the processor 120 may set a task that has a higher probability of being used to have a higher priority. According to an embodiment, when setting a priority order, the processor 120 may exclude a designated task (e.g., a task or a routine that complies with exceptions) among the predicted tasks, or may apply (or set) a weight (e.g., minus weight) related to the designated task.

According to various embodiments, in order to increase accuracy of task recommendation, exception handling may be performed on a task that is highly accessible by the user so as to except the task from a recommended task. For example, exception handling (or excluding or applying a minus weight) may be performed on a task (e.g., an application or a function) which the user is capable of easily searching for and executing via the electronic device 101, so as to except the task from a recommended task. According to an embodiment, a task or routine on which exception handling is to be performed may be included in, for example, predetermined exceptions and may be managed. According to an embodiment, the exceptions may include a task that is easily accessible by the user or was used immediately before, such as a flow (e.g., a user interface flow) (e.g., a task (e.g., an application) fixedly provided in a home screen (or a page) if task switching is performed via the home screen) performed up to access to a user interface (e.g., a recent screen) including an application list (e.g., a recent list and a recommend list) when the user performs task switching, a task (e.g., an edge, a floating button, a lock screen, and/or a widget) associated with a predetermined component (e.g., a shortcut user interface component), a task in which the user staved (or used) before performing task switching, and/or an application (e.g., an application corresponding to a screenshot or icon in a recent list) included in the recent list, and may perform exception handling on (e.g., excluding or applying a minus weight to) a task that complies with exceptions from a recommended task. According to various embodiments, the process of performing exception handling on a task will be described with reference to the drawings described below.

In operation 705, the processor 120 may perform sorting of recommended tasks based on the priority order and may configure a list thereof (e.g., a recommend list). According to an embodiment, the processor 120 may sort recommended tasks in order of priority, and may configure the list including a predetermined number of tasks, the predetermined number being designated for a predetermined area (e.g., the second area 420 of FIG. 4). According to an embodiment, if the number of recommended tasks is greater than the predetermined number, the processor 120 may configure the recommend list by setting groups of recommended tasks based on the predetermined number such as a first recommended group with the highest priority, a second recommended group with a second priority, and a third recommended group with a third priority.

In operation 707, the processor 120 may provide the recommended task list. According to an embodiment, the processor 120 may dispose the recommend list including the recommended tasks in a designated area (e.g., the second area 420 of FIG. 4) of the user interface, and may display the same.

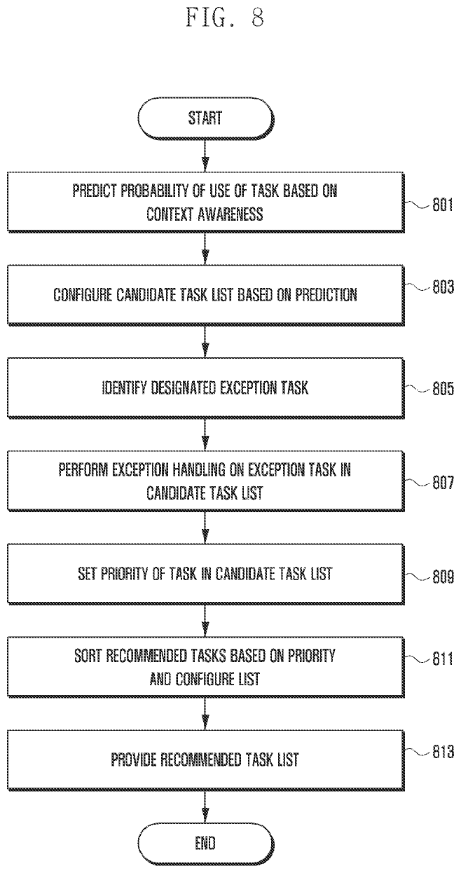

FIG. 8 is a flowchart illustrating an operation method of the electronic device 101 according to various embodiments.

According to an embodiment, FIG. 8 illustrates an example in which the electronic device 101 predicts a recommendable task based on context awareness, and performs exception handling on (e.g., excluding or adjusting a weight to) at least one task from the predicted task.

Referring to FIG. 8, in operation 801, the processor 120 of the electronic device 101 may predict the probability of use of a task based on the context awareness for a recommended task. According to an embodiment, the processor 120 may recognize and determine various contexts related to use of the electronic device 101 by a user, and may predict a task executable by the user at the present point. For example, the executable task may be any task which can be used by the user at the present point, and may include an application, a function, a content, and/or a link usable by the user. According to an embodiment, the processor 120 may estimate the probability of use of a task based on the frequency of use of the task for each time, place, and/or situation.

In operation 803, the processor 120 may configure a candidate task list based on a result of estimation (e.g., the estimated probability of use of a task). According to an embodiment, the processor 120 may configure a candidate task list including all predicted tasks.

In operation 805, the processor 120 may identify a designated exception task (e.g., a task or routine which complies with exceptions). According to an embodiment, the exceptions may include a task that is easily accessible by the user or was used immediately before, such as a flow (e.g., a user interface flow) (e.g., a task (e.g., an application) fixedly provided in a home screen (or a page) if task switching is performed via the home screen) performed up to access to a user interface (e.g., a recent screen) including an application list (e.g., a recent list and a recommend list) when the user performs task switching, a task (e.g., an edge, a floating button, a lock screen, and/or widget) associated with a predetermined component (e.g., a shortcut user interface component), a task which the user used (stayed) before performing task switching, and/or an application (e.g., an application corresponding to a screenshot or icon in a recent list) included in the recent list.

In operation 807, the processor 120 may perform exception handling on an exception task from the candidate task list. According to an embodiment, the processor 120 may exclude an exception task (e.g., a task or a routine that complies with exceptions) among the predicted tasks, or may apply (or set) a weight (e.g., a minus weight) related to the exception task. According to various embodiments, in order to increase accuracy of a task recommendation, exception handling may be performed on a task that is highly accessible by the user so as to except the task from a recommended task. For example, exception handling (or excluding or applying a minus weight) may be performed on a task (e.g., a task that complies with exceptions) which the user is capable of easily searching for and executing via the electronic device 101 so as to except the task from a recommended task.

In operation 809, the processor 120 may set a priority order in association with the candidate task list. According to an embodiment, the processor 120 may set a task that has a higher probability of being used to have a higher priority in the candidate task list. According to an embodiment, the processor 120 may exclude an exception task (e.g., a task or a routine that complies with exceptions) among the predicted tasks, or may set a low priority using a weight (e.g., minus weight) related to the designated task.

In operation 811, the processor 120 may perform sorting of recommended tasks based on the priority order and may configure a list thereof (e.g., a recommend list). According to an embodiment, the processor 120 may sort recommended tasks in order of priority, and may configure the list including a predetermined number of tasks, the predetermined number being designated for a predetermined area (e.g., the second area 420 of FIG. 4). According to an embodiment, if the number of recommended tasks is greater than a predetermined number, the processor 120 may configure the recommend list by setting groups of recommended tasks based on the predetermined number such as a first recommended group with the highest priority, a second recommended group with a second priority, and a third recommended group with a third priority.

In operation 813, the processor 120 may provide the recommended task list. According to an embodiment, the processor 120 may dispose the recommend list including the recommended tasks in a designated area (e.g., the second area 420 of FIG. 4) of the user interface, and may display the same.

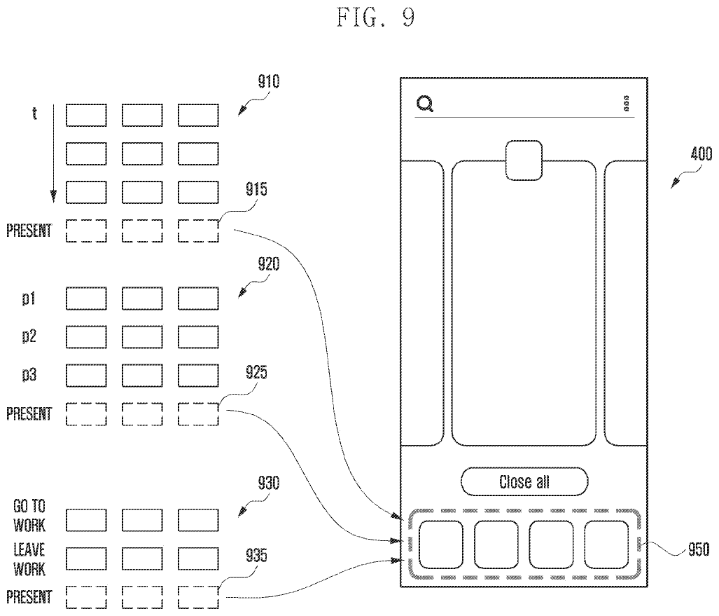

FIG. 9 is a diagram illustrating an example of providing a user interface according to various embodiments.

According to an embodiment, FIG. 9 illustrates an example in which the electronic device 101 predicts a recommendable task based on context awareness, and provides a recommend list related to a recommended task based on a result of prediction. According to various embodiments, a recommendable task may be any task which can be used by a user at the present point, and may include at least one of an application, a function, a content, and/or a link usable by the user.

Referring to FIG. 9, the electronic device 101 may use, for example, a sensor, communication, and/or computing capability in order to recognize and determine various contexts related to use of the electronic device 101 by the user, and may predict a task executable by the user at the present point. According to an embodiment, the processor 120 may be aware of context information via collecting and exchanging context information related to a task, and may provide a task appropriate for the context of the user via a process such as interpretation and inference. According to an embodiment, the electronic device 101 may use a learning module learned using an artificial intelligence algorithm, and may predict (or calculate) a task which is expected to be executed by the user.

According to an embodiment, the electronic device 101 may be aware of context information of the user, such as a task usage pattern, a usage situation (e.g., a time, a place, a predetermined situation), and/or the frequency of use for each usage situation, and may infer (or predict) one or more tasks expected to be executed (or expected to have a high probability of being used) by the user at the present based on the context information.

According to an embodiment, referring to example 1 of an element 910, the electronic device 101 may manage a task usage history related to a recent time interval (t). The electronic device 101 may predict the probability of use of each task at the present point based on the frequency of use of the task in the recent time interval, and may provide a task 915 having a high probability of use to a recommendation area 950 of the user interface 400. According to an embodiment, the electronic device 101 may identify the frequency of use of a task within a predetermined range (e.g., a predetermined time value (e.g., N hours ago)) from the present time point, and/or the frequency of use of a task for each time interval within a predetermined range.

According to an embodiment, referring to example 2 of an element 920, the electronic device 101 may manage a task usage history related to a place (e.g., place 1 (P1), place 2 (P2), and place 3 (P3)). The electronic device 101 may predict the probability of use of each task in a corresponding place at the present point based on the frequency of use of the task for each place, and may provide a task 925 having a high probability of use to the recommendation area 950 of the user interface 400.

According to an embodiment, referring to example 3 of an element 930, the electronic device 101 may manage a task usage history related to a situation (e.g., situation 1 (go to work) and situation 2 (leave work)). The electronic device 101 may predict the probability of use of each task in association with a corresponding situation at the present point based on the frequency of use of the task for each situation, and may provide a task 935 having a high probability of use to the recommendation area 950 of the user interface 400.

According to various embodiments, the electronic device 101 may predict a probability of use based on a combination of various pieces of context information related to various usage situations. According to an embodiment, based on a result of context awareness related to at least one of element 910, element 920, and/or element 930, a task expected to be executed (or used) by the user at the present point may be predicted. The electronic device 101 may provide a task obtained as the result of prediction to the recommendation area 950 of the user interface 400, according to a priority order determined based on a probability of use. According to an embodiment, the electronic device 101 may predict a probability of use by applying a weight for a priority order for each usage situation. For example, a probability of use may be predicted by applying a weight for a priority order to a situation (e.g., a predetermined place or a predetermined situation (e.g., way to work) closer to the situation of the user at the present time in association with a usage pattern, a time, a place, or a predetermined situation

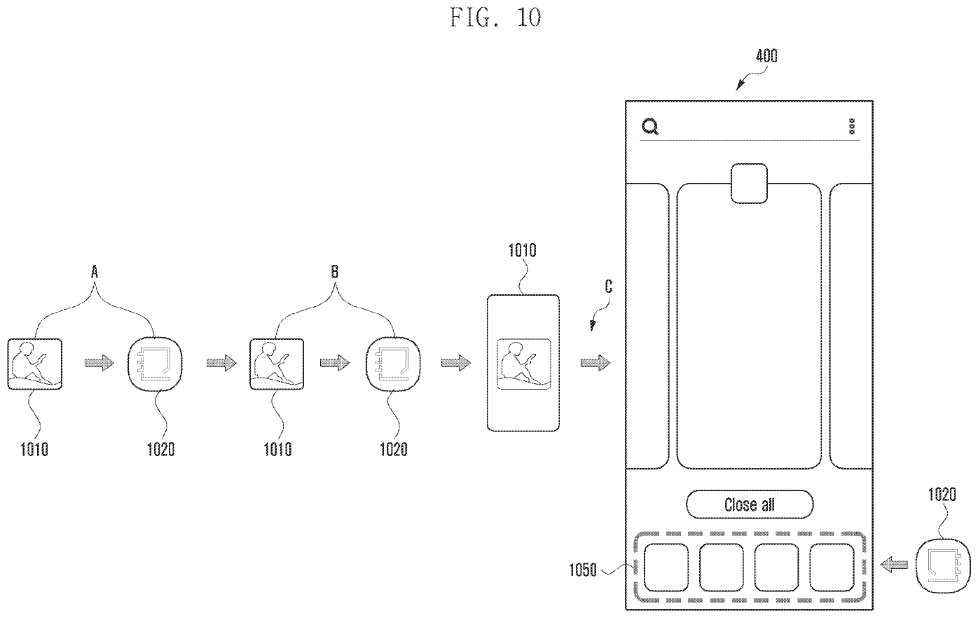

FIG. 10 is a diagram illustrating an example of providing a user interface according to various embodiments.

According to an embodiment, FIG. 10 illustrates an example in which the electronic device 101 predicts a recommendable task based on context awareness, and provides a recommend list related to a recommended task based on a result of prediction. According to various embodiments, a recommendable task may be any task which can be used by a user at the present point, and may include at least one of an application, a function, a content, and/or a link usable by the user.

Referring to FIG. 10, the electronic device 101 may use, for example, a sensor, communication, and/or computing capability in order to recognize and determine various contexts related to use of the electronic device 101 by the user, and may predict a task executable by the user at the present point. According to an embodiment, the processor 120 may be aware of context information via collecting and exchanging context information related to a task, and may provide a task appropriate for the context of the user via a process such as interpretation and inference. According to an embodiment, the electronic device 101 may use a learning module learned using an artificial intelligence algorithm, and may predict (or calculate) a task which is expected to be executed by the user.

According to an embodiment, the electronic device 101 may predict a recommended task based on the usage history of tasks which are used consecutively and repeatedly. According to an embodiment, as shown in the example of element A and element B, the user repeats a usage pattern that uses a first application 1010 and consecutively uses a second application 1020 after using the first application 1010. For example, if the electronic device 101 is capable of managing a usage history in which the second application 1020 is consecutively used after the application 1010 is used, and the number/ratio of the applications which are consecutively used is greater than a predetermined threshold value, the second application 1020 may be provided as a recommended task when task switching is performed after the first application 1010 is used, or a weight may be applied to the second application 1020 so as to increase a predicted probability of use.

According to an embodiment, as shown in the example of element C, if the electronic device 101 switches a task (e.g., accessing the user interface 400 including an application list (e.g., a recent list and a recommend list)) from the first application 1010, the electronic device 101 may include the second application 1020 in the recommend list and provide the same to the recommendation area 1050 of the user interface 400. According to an embodiment, the electronic device 101 may increase the predicted probability of use of the second application 1020, so as to set the second application 1020 to have a high priority, and to include the second application 1020 in the recommend list.

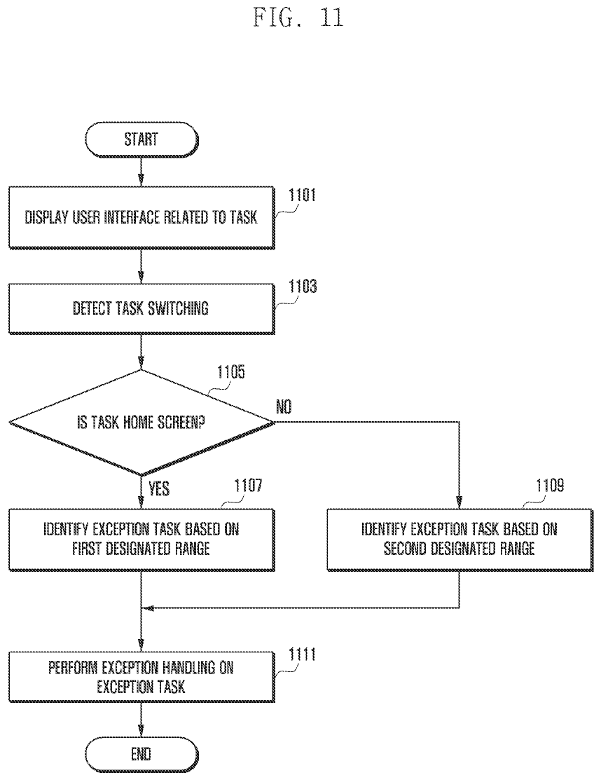

FIG. 11 is a flowchart illustrating an operation method of the electronic device 101 according to various embodiments.

According to an embodiment, FIG. 11 illustrates an example in which, when performing task switching, the electronic device 101 identifies an exception task based an on-going task, and performs exception handling on (e.g., excluding, or adjusting a weight of) the identified exception task.

Referring to FIG. 11, in operation 1101, the processor 120 of the electronic device 101 may display a user interface related to a task. According to an embodiment, the task may be a task related to a home screen (or a page), or may be a task related to a predetermined task (e.g., an application).

In operation 1103, the processor 120 may detect task switching. According to an embodiment, the processor 120 may receive a user input for switching a task in the state in which the user interface related to a task (e.g., an application execution screen or a home screen) is displayed. According to an embodiment, task switching may be performed based on, for example, a user input via a predetermined button for displaying a user interface including a recent list related to a recently used application and a recommend list related to a recommended task in the electronic device 101. According to an embodiment, task switching may be performed based on, for example, a predetermined voice input.

In operation 1105, the processor 120 may determine whether a task corresponds to a home screen. According to an embodiment, if task switching is performed in the state in which a task is being executed, the processor 120 may identifies whether the on-going task is related to the home screen or another task (e.g., a predetermined application).

If it is identified that the task corresponds to the home screen in operation 1105 (e.g., “Yes” in operation 1105), the processor 120 may identify an exception task based on a first designated range in operation 1107. According to an embodiment, if task switching (e.g., accessing a recent screen) is performed in the home screen, or in a start task (e.g., a start application) via the home screen, the processor 120 may identify an application in a recent list included in the first designated range, a task (e.g., an edge, a floating button, a lock screen, and/or a widget) associated with a component (e.g., a shortcut user interface component) in the home screen, as an exception task. For example, the processor 120 may identify the task included in the first designated range as an exception task on which exception handling to except the task from a recommended task is to be performed.

If it is identified that the task does not correspond to the home screen (or corresponds to another task) in operation 1105 (e.g., “No” in operation 1105), the processor 120 may identify an exception task based on a second designated range in operation 1109. According to an embodiment, if task switching (e.g., accessing a recent screen) is performed in a start task (e.g., a start application) without passing through the home screen, the processor 120 may identify an application in a recent list included in a second designated range as an exception task. For example, the processor 120 may identify the task included in the second designated range as an exception task on which exception handling to except the task from a recommended task is to be performed.

In operation 1111, the processor 120 may perform exception handling on the exception task. According to an embodiment, the processor 120 may exclude the identified exception task or may apply (or set) a weight (e.g., a minus weight) related to the exception task, when configuring a recommend list. According to various embodiments, in order to increase accuracy of task recommendation, exception handling may be performed on a task that is highly accessible by a user so as to except the task from a recommended task. For example, exception handling (or excluding, or applying a minus weight) may be performed on a task (e.g., a task that complies with exceptions) which the user is capable of easily searching for and executing via the electronic device 101, so as to except the task from a recommended task.

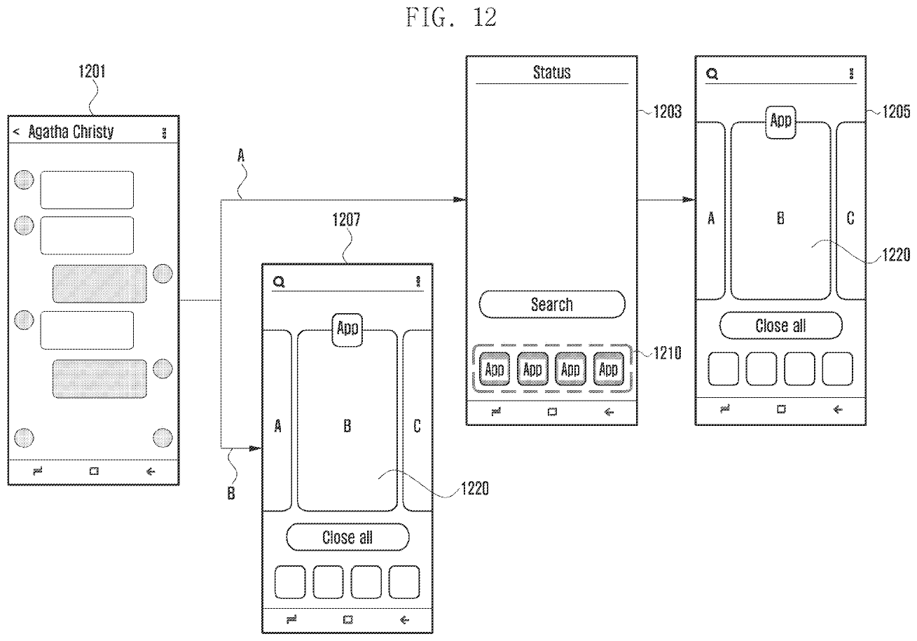

FIG. 12 is a diagram illustrating an example of providing a user interface according to various embodiments.

According to an embodiment, FIG. 12 illustrates an example of performing exception handling on a task (e.g., an application) associated with a task (e.g., a short user interface component) that is highly accessible by a user.

Referring to FIG. 12, in the example of a screen 1201, the electronic device 101 may be in the state of displaying a user interface (e.g., an application execution screen) related to a predetermined task (e.g., an application).

According to an embodiment, in the state as shown in the screen 1201, the user may access a recent screen 1205 via task switching by passing through a home screen 1203 according to routine A, or the user may access a recent screen 1207 via task switching without passing though the home screen 1203 according to routine B.

According to an embodiment, referring to routine A, if the electronic device 101 accesses the recent screen 1205 by passing through the home screen 1203 from the screen 1201, the electronic device 101 may identify a task (e.g., a shortcut application designated by the user) associated with a component 1210 (e.g., a shortcut user interface component) of the home screen 1203 and an application 1220 (e.g., application A, application B, or application C) in a recent list as exception tasks. For example, the electronic device 101 may exclude a task included in a first designated range from a recommended task.

According to an embodiment, referring to routine B, if the electronic device 101 accesses the recent screen 1207 from the screen 1201 without passing through the home screen 1203, the electronic device 101 may identify the application 1220 (e.g., application A, application B, or application C) in the recent list as an exception task. For example, the electronic device 101 may exclude a task included in a second designated range from a recommended task.

According to various embodiments, if a task (e.g., a recent application in the recent list) located in a recent screen (e.g., a user interface) that provides a recommend list is present, the corresponding task may be excluded from recommendation. According to various embodiments, if the user passes through the home screen before accessing the recent screen, a task (e.g., an application or a widget) fixedly provided in the home screen may be excluded from recommendation.

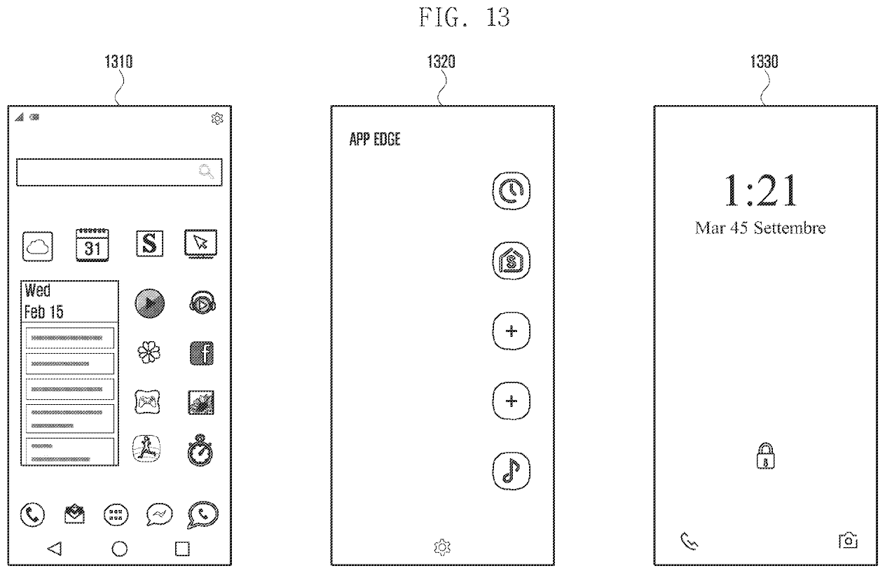

FIG. 13 is a diagram illustrating an example of providing a user interface according to various embodiments.

According to an embodiment, FIG. 13 illustrates an example of performing exception handling on a task (e.g., an application) associated with a task (e.g., a short user interface component) that is highly accessible by a user.

Referring to FIG. 13, the electronic device 101 may exclude, from a recommended task, an application in a recent list, a task fixedly provided in a home screen, and a task associated with a component in the home screen (e.g., a floating button and a widget in a screen 1310, an edge in a screen 1320, and a lock screen in a screen 1330), as illustrated in FIG. 12.

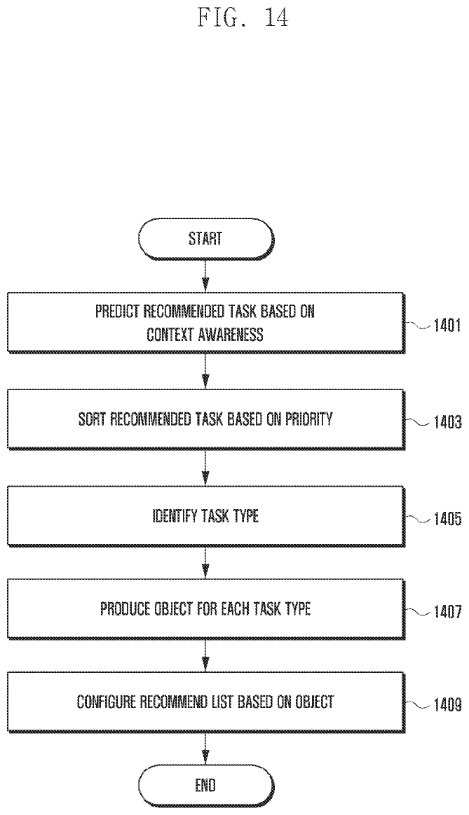

FIG. 14 is a flowchart illustrating an operation method of the electronic device 101 according to various embodiments.

According to an embodiment, FIG. 14 illustrates an example in which the electronic device 101 produces task objects (e.g., an icon, text (e.g., link information), an image, a video, a thumbnail, and/or a widget icon) based on various recommended task types (e.g., an application type, a function type, a content type, and a link type), and provides a recommend list based on the task objects.

Referring to FIG. 14, in operation 1401, the processor 120 of the electronic device 101 may predict a recommended task based on context awareness.

In operation 1403, the processor 120 may sort recommended tasks based on priority.

In operation 1405, the processor 120 may identify a task type. According to an embodiment, the processor 120 may identify the task type of each of the recommended tasks in a sorted order. According to an embodiment, the task types may include various task types, for example, an application, a function, a content, and/or link.

In operation 1407, the processor 120 may produce an object (e.g., a task object) for each task type. According to an embodiment, the processor 120 may produce a task object in at least one form such as an icon, text (e.g., link information), an image, a video, a thumbnail, and/or a widget icon, based on a task type.

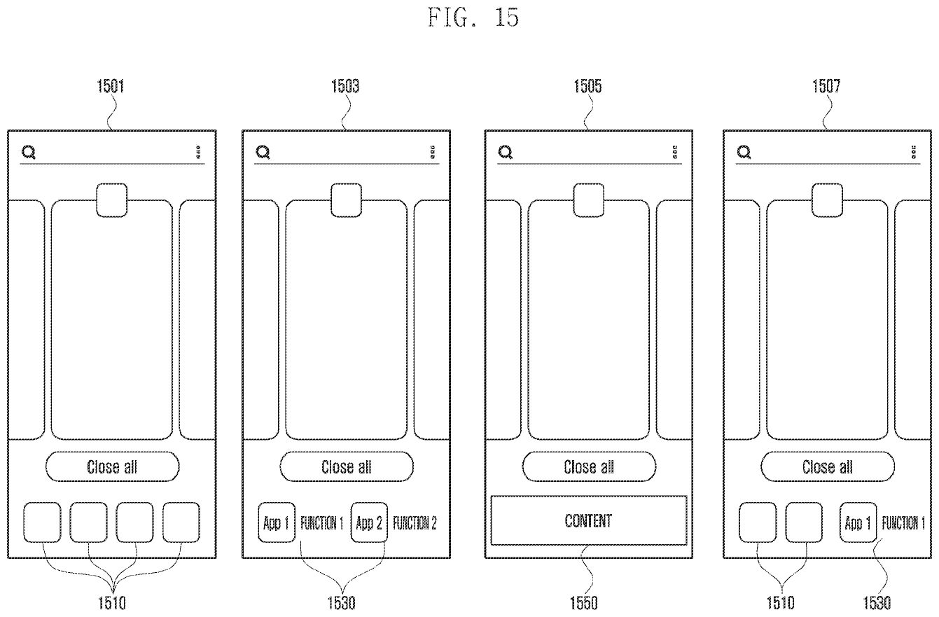

In operation 1409, the processor 120 may configure a recommend list based on the object. According to an embodiment, if a task having a high probability of being used, such as a function, a content, and/or a link, in addition to an application, is present at the point in time at which a user performs task switching (e.g., at the point in time of accessing a recent screen), the processor 120 may provide a related object (e.g., a task object) capable of executing the corresponding task to a recommendation area (e.g., the second area 420 of FIG. 4) of a user interface. According to an embodiment, a process of configuring a recommend list based on an object, disposing the recommend list in a corresponding area (e.g., the second area 420 of FIG. 4) of a user interface, and providing the same will be described with reference to FIG. 15.

FIG. 15 is a diagram illustrating an example of providing a user interface according to various embodiments.

According to an embodiment, FIG. 15 illustrates an example in which the electronic device 101 produces task objects (e.g., an icon, text (e.g., link information), an image, a video, a thumbnail, and/or a widget icon) based on various recommended task types (e.g., an application type, a function type, a content type, and a link type), and provides a recommend list based on the task objects. According to various embodiments, if a task having a high probability of being used, such as a function, a content, and/or a link, in addition to an application, is present at the point in time at which a user performs task switching (e.g., at the point in time at which accessing a recent screen is performed), the electronic device 101 may provide a related object (e.g., a task object) capable of executing the corresponding task to a recommendation area (e.g., the second area 420 of FIG. 4) of a user interface.

Referring to FIG. 15, the electronic device 101 may recommend various tasks such as a function, a link, and/or a content, in addition to an application, in a recommendation area.

According to an embodiment, a screen 1501 shows an example of the case in which a task type is a first type (e.g., an application type), and a task object related to the first type is a first task object 1510 (e.g., an application icon). According to an embodiment, the first task object 1510 may be provided in the form of an icon. According to an embodiment, depending on the size of the object, a first predetermined number (e.g., 4) of first task objects 1510 may be included in the recommendation area. For example, the recommendation area may be provided as an application recommendation area.

According to an embodiment, a screen 1503 shows an example of the case in which a task type is a second type (e.g., a function type), and a task object related to the second type is a second task object 1530 (e.g., an application icon+function information). According to an embodiment, the second task object 1530 may be provided in the form including an application icon and function information related to a function recommended to a user in association with the corresponding application. According to an embodiment, depending on the size of the object including an icon+function information, a second predetermined number (e.g., 2) of second task objects 1530 may be included in the recommendation area. For example, the recommendation area may be provided as a function recommendation area.

According to an embodiment, a screen 1505 shows an example of the case in which a task type is a third type (e.g., a content type), and a task object related to the third type is a third task object 1550 (e.g., a content thumbnail+content information). According to an embodiment, the third task object 1550 may be provided in the form including a representative image and/or related information (e.g., the name of a content to be reproduced) which enables identification of a corresponding content depending on the type of the content (e.g., audio reproduction and/or video reproduction type). According to an embodiment, depending on the size of the object including content information (e.g., an image and a name), a third predetermined number (e.g., 1) of third task objects 1550 may be included in the recommendation area. For example, the recommendation area may be provided as a content recommendation area.

According to an embodiment, a predetermined number (a previously set number) (e.g., N) of task objects may be included in the recommendation area, the number being predetermined based on a task object type. According to an embodiment, the predetermined number may be variously set based on the size of the recommendation area.

According to an embodiment, recommended tasks may include various types of tasks according to priority. According to an embodiment, the recommendation area may be provided in the form including different task objects 1510 and 1530 corresponding to task types of tasks recommended. For example, as shown in a screen 1507, if a task having a first priority and a task having a second priority correspond to a first type, and a task having a third priority corresponds to a second type, the recommendation area may include two first task objects 1510 and one second task object 1530.

According to an embodiment, if the number of recommended tasks for a recommend list of the recommendation area is greater than a predetermined number designated in association with a task object for the recommendation area, task objects of tasks, the number of which corresponds to the predetermined number, may be provided in the recommendation area according to priority, and task objects of tasks with subsequent priorities may be provided in the recommendation area via switching according to a user input. According to an embodiment, a task object (e.g., a first recommended group) displayed in the recommendation area may be switched into another task object (e.g., a second recommended group) according to a user input, and may be displayed. For example, a task object (e.g., the second recommended group) related to another recommended task having a lower priority than that of the first recommended group may be provided via switching.

According to an embodiment, it is assumed that a first recommended group of the task objects 1510 on the screen 1501 has the highest priority, a second recommended group of the task objects 1530 on the screen 1503 has the second priority, and a third recommended group of a task object 1550 on the screen 1505 has the third priority. In the assumption, when task switching is performed, the task objects 1510 of the first recommended group may be provided in the recommendation area, the task objects 1530 of the second recommended group with the second priority may be provided in the recommendation area according to a user input, and the task object 1550 of the third recommended group with the third priority may be provided in the recommendation area according to a user input. For example, according to a user input for navigation related to a recommended task in the recommendation area, the screen 1501 to the screen 1505 may be provided sequentially.

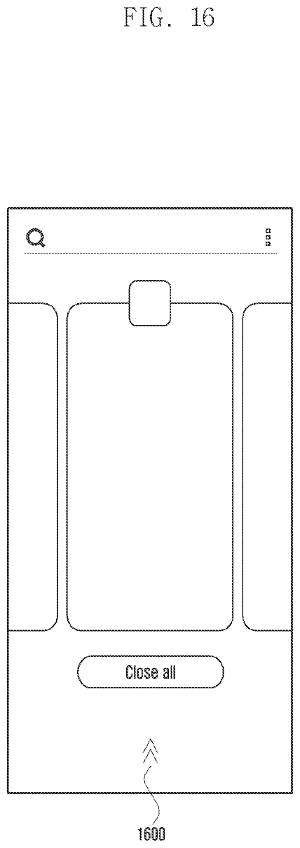

FIG. 16 is a diagram illustrating an example of providing a user interface according to various embodiments.

According to an embodiment, FIG. 16 illustrates an example of providing a predetermined cue object 1600 if a recommended task is not present based on the current context of a user.

As illustrated in FIG. 16, if a recommended task is not present when task switching is performed, the electronic device 101 may provide the cue object 1600 for navigating all tasks (e.g., all applications) in the recommendation area. For example, the electronic device 101 may provide a user interface including an application list related to all applications, based on a user input via the cue object 1600.

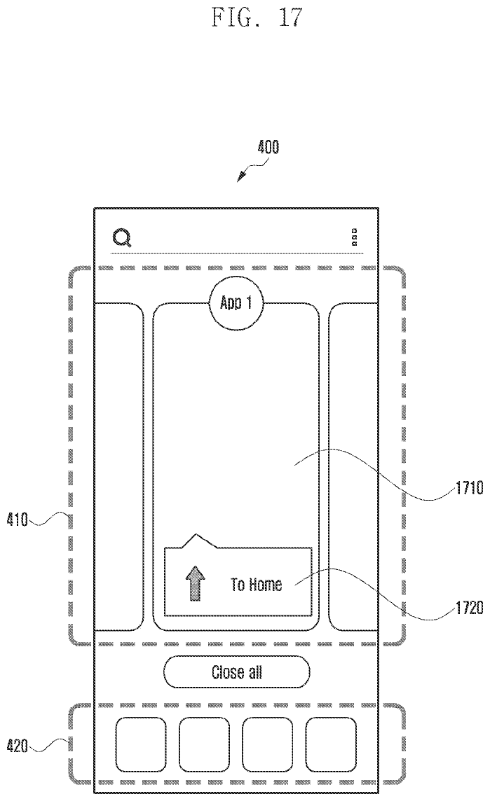

FIG. 17 is a diagram illustrating an example of providing a user interface according to various embodiments.

According to an embodiment, FIG. 17 illustrates an example of additionally providing a recommended task (e.g., a function or a content) based on a recent application in the recent area 410.

Referring to FIG. 17, the user interface 400 may include the recent area 410 for a recent list related to a recently used application and the recommendation area 420 for a recommend list related to a recommended task.

According to an embodiment, the recommendation area 420 may provide the recommend list based on a task object related to a task which is expected to have a high probability of being used (or executed) by a user based on context related to the user. According to an embodiment, the task may include at least one element that the user is capable of using in the electronic device 101, such as an application, a function, a content, and/or a link, which is expected to be used (or executed) subsequently by the user.

According to an embodiment, the recent area 410 may provide the recent list based on a screenshot (or a shortcut or a thumbnail) related to at least one application (e.g., application A, application B, and application C) that the user recently used. According to an embodiment, as illustrated in FIG. 17, a related recommended task (e.g., a related function or a related content) may be additionally provided in association with an application 1710 displayed in the center of the recent area 410. For example, the electronic device 101 may recommend a task (e.g., a function or a content) based on the corresponding application via a bubble popup 1720. According to an embodiment, if a task (e.g., a function or a content) having a high probability of being used is present at the point in time at which task switching is performed, the electronic device 101 may provide a task object for executing the corresponding task via the bubble popup 1720. According to various embodiments, the electronic device 101 may provide at least a part of the recent area 410 as a task recommendation area based on the bubble popup 1720.

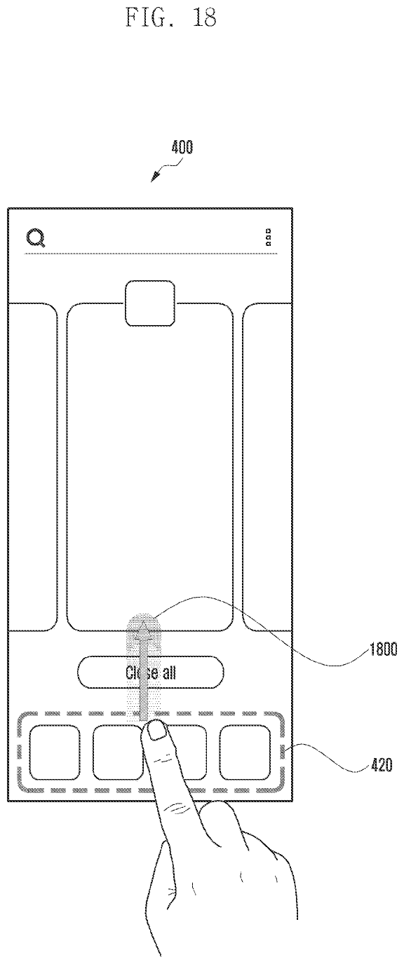

FIG. 18 is a diagram illustrating an example of performing interaction with a user via a user interface according to various embodiments.

According to an embodiment, FIG. 18 illustrates an example of performing interaction with a user via a user interface.

Referring to FIG. 18, FIG. 18 illustrates an example of providing a user input (e.g., a swipe gesture (e.g., swipe up)) for calling and providing a designated application list in the recommendation area 420 of the user interface 400. According to an embodiment, if a task that the user desires to search for is not present among recommended tasks of the recommendation area 420, the user may execute a related cue via a user input (e.g., swipe up) 1800 in the recommendation area 420. According to an embodiment, the related cue may be defined in advance, and may include, for example, a cue for moving to a user interface of an application list including information related to all applications, or a cue for moving to a user interface of a recommended task list including information related to all recommended tasks.

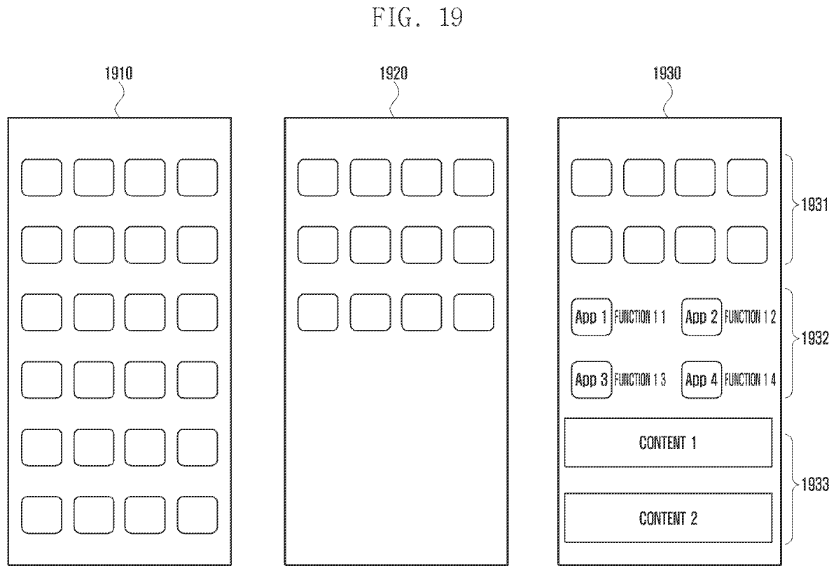

According to an embodiment, the electronic device 101 may receive a designated user input 1800 via the recommendation area 420, may call (or execute) a designated function (e.g., all applications or all recommended tasks) according to the user input 1800, and may display a user interface related to the called designated function. The example thereof is illustrated in FIG. 19.

FIG. 19 is a diagram illustrating an example of performing interaction with a user via a user interface according to various embodiments.

According to an embodiment, FIG. 19 illustrates an example of a user interface including a result of interaction with a user.

Referring to FIG. 19, a screen 1910 shows an example of providing a user interface including information related to all applications (e.g., application icons corresponding to all applications) if a designated function (or cue) is provision of information related to all applications. If a designated function (or cue) is provision of information related to a recommended task, a screen 1920 or a screen 1930 shows an example of providing a user interface including information related to all recommended tasks (e.g., task objects (e.g., a first task object, a second task object, and a third task object) corresponding to all tasks).

According to an embodiment, the screen 1920 shows an example of providing a user interface based on a first task object in consideration that a recommended task corresponds to a first type. The screen 1930 shows an example of providing a user interface including a first task object 1931, a second task object 1932, and a third task object 1933 based on a first type, a second type, and a third type, in consideration that types of recommended tasks include all of the first type (e.g., an application type), the second type (e.g., a function type), and the third type (e.g., a content type).

As illustrated in FIGS. 18 and 19, according to various embodiments, the electronic device 101 may provide interaction with a user via the recommendation area 420. For example, the electronic device 101 may call a designated function (e.g., all applications or all recommended tasks) based on a user input via the recommendation area 420, and may display a user interface (e.g., the screen 1910, the screen 1920, or the screen 1930) related to the called designated function. Through the above, if a task that the user desires to search for is not present in the recent area 410 and the recommendation area 420, the user may display a user interface related to a designated function by providing a designated user input (e.g., swipe up) via the recommendation area 420, and may easily identify a task desired by the user via the user interface.

An operation method of the electronic device 101 according to various embodiments of the disclosure may include: an operation of displaying a first user interface on a display (e.g., the display device 160 of FIG. 1); an operation of receiving a user input related to task switching; an operation of configuring a second user interface (e.g., the user interface 400 of FIG. 4) including a recent list related to a recently used application and a recommend list related to a recommended task; and an operation of switching the first user interface to the second user interface and displaying the second user interface.

According to various embodiments, the operation of configuring the second user interface may include: an operation of predicting a recommended task related to at least one task associated with user context, and an operation of configuring the recommend list based on a task object related to the recommended task.

According to various embodiments, the recommended task is a task having a high probability of being used by a user via task switching, and may include at least one of an application, a function, contents, or a link.

According to various embodiments, the operation of configuring the recommend list may include an operation of performing exception handling on a task which is highly accessible by the user, so as to except the task from the recommended task.

According to various embodiments, the operation of configuring the recommended task may include an operation of predicting the recommended task, and an operation of excluding a designated task from the predicted task or applying a weight related to the designated task.

According to various embodiments, the task on which exception handling is to be performed may include a flow performed up to access to the second user interface, a task associated with a predetermined component, a task in which the user stayed before task switching is performed, or at least one of applications included in the recent list.

According to various embodiments, the operation of configuring the recommend list may include: an operation of predicting the recommended task, an operation of configuring a candidate task list based on a result of the prediction; an operation of identifying a designated exception task; an operation of performing exception handing on the exception task in the candidate task list; and an operation of providing the recommend list based on the exception handing performed on the exception task. in the candidate task list.

According to various embodiments, the operation of displaying the second user interface may include: an operation of disposing the recent list in a first area of the second user interface, and disposing the recommended list in a second area of the second user interface, so as to display the recent list and the recommended list together, and at the same time, to display the recent list and the recommended list distinctively.

According to various embodiments, the operation of configuring the recommend list may include: an operation of predicting a task which is expected to be executed by the user using a learning model that is learned using an artificial intelligence algorithm.

Embodiments of the disclosure disclosed in the specification and the accompanying drawings are merely examples for easily describing the technical contents of the disclosure and helping understanding of the disclosure, but the scope of the disclosure is not limited thereto. Therefore, it should be construed that the scope of the disclosure includes all modifications or modified forms obtained based on the technical idea of the disclosure, in addition to the embodiments disclosed herein.

1. An electronic device comprising:
a display; and
at least one processor operatively connected to the display,
wherein the processor is configured to:
display a first user interface via the display;
receive a user input related to task switching;
configure a second user interface including a recent list related to a recently used application and a recommend list related to a recommended task; and
switch the first user interface to the second user interface and display the second user interface.

2. The electronic device as claimed in claim 1, wherein the processor is further configured to predict at least one recommended task associated with user context, and to configure the recommend list based on a task object related to the recommended task.

3. The electronic device as claimed in claim 2, wherein the recommended task is a task having a high probability of being used by a user via task switching, and comprises at least one of an application, a function, contents, or a link.

4. The electronic device as claimed in claim 2, wherein the processor is further configured to perform exception handling on a task which is highly accessible by a user, so as to except the task from the recommended task.

5. The electronic device as claimed in claim 4, wherein the processor is further configured to predict the recommended task, and to exclude a designated task from the predicted task or to apply a weight related to the designated task.

6. The electronic device as claimed in claim 5, wherein the task on which exception handling is performed includes a flow performed up to accessing the second user interface, a task associated with a predetermined component, a task in which a user stayed before task switching is performed, or at least one application included in the recent list.

7. The electronic device as claimed in claim 2, wherein the processor is further configured to:
predict the recommended task, and configure a candidate task list based on a result of the prediction;
identify a designated exception task;
perform exception handling on the exception task in the candidate task list; and
provide the recommend list based on the exception handling performed on the exception task in the candidate task list.

8. The electronic device as claimed in claim 1, wherein the user input related to task switching comprises a user input based on a designated button for displaying the second user interface or a designated voice input.

9. The electronic device as claimed in claim 1, wherein the processor is further configured to:
divide the second user interface into a first area and a second area; and
display the recent list and the recommend list together and distinctively based on the first area and the second area.

10. The electronic device as claimed in claim 1, wherein the processor is further configured to predict a task which is expected to be executed by a user using a learning model that is learned using an artificial intelligence algorithm.

11. An operation method of an electronic device, the method comprising:
displaying a first user interface on a display;
receiving a user input related to task switching;
configuring a second user interface including a recent list related to a recently used application and a recommend list related to a recommended task; and
switching the first user interface to the second user interface and displaying the second user interface.

12. The method as claimed in claim 11, wherein configuring the second user interface comprises:
predicting at least one recommended task associated with user context; and
configuring the recommend list based on a task object related to the recommended task,
wherein the recommended task is a task which has a high probability of being used by a user via task switching, and includes at least one of an application, a function, contents, or a link.

13. The method as claimed in claim 12, wherein the configuring of the recommend list comprises performing exception handling on a task which is highly accessible by the user, so as to except the task from the recommended task,
wherein the performing of exception handling comprises excluding a designated task from the predicted task, or applying a weight related to the designated task, and
wherein the task on which exception handling is performed includes a flow performed up to access to the second user interface, a task associated with a predetermined component, a task in which the user stayed before task switching is performed, or at least one of applications included in the recent list.

14. The method as claimed in claim 12, wherein the configuring of the recommend list comprises:
predicting the recommended task, and configuring a candidate task list based on a result of the prediction;
identifying a designated exception task;
performing exception handling on the exception task in the candidate task list; and
providing the recommend list based on the exception handling performed on the exception task in the candidate task list.

15. The method as claimed in claim 12, wherein the displaying of the second user interface comprises:
dividing the second user interface into a first area and a second area, and displaying the recent list and the recommend list together and distinctively based on the first area and the second area.
